(19) United States
(12) Patent Application Publication
(10) Pub. No.: US 2019/0350176 A1
(43) Pub. Date: Nov. 21, 2019

(54) HEXAGONAL BEE HIVE

(71) Applicant: James F. Perkins, Williamson, GA (US)

(72) Inventor: James F. Perkins, Williamson, GA (US)

(21) Appl. No.: 16/416,471

(22) Filed: May 20, 2019

Related U.S. Application Data
(60) Provisional application No. 62/674,158, filed on May 21, 2018.

(51) Int. Cl. A01K 47/06; A01K 47/02

(52) U.S. Cl. CPC A01K 47/06; A01K 47/02

(57) ABSTRACT

A hexagonal beehive includes a hive body having a hexagonal cross-section. The hive body has a front, a back, a top half, and a bottom half and defines an open interior. The front has a landing deck and defines an entrance opening above the landing deck. The bottom and rear have sealable vent portions. The beehive includes hexagonal frame members having outer peripheries that are sized and shaped to be positionable within the open interior. Each frame member has an outer frame having a first thickness and an inner frame having a smaller second thickness such that the inner frames of adjacent frame members are spaced apart from one another. Each hexagonal frame member includes a plurality of access channels. Each inner frame defines a central opening. The beehive further includes a base.

### CROSS-REFERENCES TO RELATED APPLICATIONS

This application is a nonprovisional of and claims the benefit of priority to U.S. Provisional Patent Application No. 62/674,158, filed May 21, 2018, entitled “Hexagonal Bee Hive,” the content of which is herein incorporated in its entirety.

### BACKGROUND OF THE INVENTION

Conventional beehives, such as Langstroth hive designs, utilize rectangular frames that encourage inefficient brood patterns in which the food sources (pollen and honey) are located further away from the brood than necessary. For example, the brood pattern typically involves the brood being formed on a bottom of the hive, with a layer of pollen and a layer of honey positioned above the brood. Not only are such brood patterns inefficient, but these patterns also make it more difficult to moderate the hive temperature, which leads to many hives dying over the colder winter months. Solutions to these and other problems are provided by the present invention.

### BRIEF SUMMARY OF THE INVENTION

Embodiments of the present invention are directed to beehives that offer greater strength and encourage more efficient brooding patterns as compared to conventional beehives. Embodiments achieve these and other benefits through a number of inventive features that include utilizing a hexagonal and expandable hive design that allows a beekeeper to regulate the expansion of the colony of bees. Improved ventilation and insulation of the hive is also provided.

In one embodiment, a hexagonal beehive is provided. The hexagonal beehive may include a hive body having a hexagonal cross-section. The hive body may include a front, a back, a top half, and a bottom half. The front may include a landing deck and may define an entrance opening that is raised above the landing deck. The rear may include a first sealable vent element and the bottom may include a second sealable vent element. The hive body may define an open interior. The hexagonal beehive may also include a plurality of hexagonal frame members, each having outer peripheries that are sized and shaped to substantially match inner dimensions of the hive body such that the plurality of hexagonal frame members are positionable within the open interior of the hive body. Each of the plurality of hexagonal frame members may include an outer frame having a first thickness and an inner frame having a second thickness that is smaller than the first thickness such that the inner frames of adjacent ones of the plurality of frame members are spaced apart from one another. Each hexagonal frame member may include a plurality of access channels. The hexagonal beehive may further include a base configured to support the hive body.

In some embodiments, a lower edge of the top half of the hive body may extend beyond an upper edge of the bottom half of the hive body. In some embodiments, at least some of the plurality of access channels extend into at least two of the sides of the inner frame. In some embodiments, each of the plurality of hexagonal frame members further includes a plurality of wires coupled with one or both of the outer frame and the inner frame, each of the plurality of wires extending across the central opening. In some embodiments, the hexagonal beehive may further include a false back that is positionable adjacent any of the plurality of hexagonal frame members to regulate a size of a bee colony within the beehive. The false back may include a vent portion. In some embodiments, the front and/or the back define an observation window. In some embodiments, the top half may include a handle for pivoting the top half relative to the bottom half. In some embodiments, the base may include pivotable legs. In some embodiments, the inner frame and the outer frame are integral to one another.

In another embodiment, a hexagonal beehive includes a hive body having a hexagonal cross-section and defining an open interior. A front of the hive body may define at least one entrance opening. The hive body may include at least one vent element. The hexagonal beehive may also include a plurality of hexagonal frame members having outer peripheries that are sized and shaped to substantially match inner dimensions of the hive body such that the plurality of hexagonal frame members are positionable within the open interior of the hive body. Each of the plurality of hexagonal frame members may include an outer portion having a first thickness and an inner portion having a second thickness that is smaller than the first thickness such that the inner portions of adjacent ones of the plurality of frame members are spaced apart from one another. Each hexagonal frame member may include at least one access channel. Each inner portion may define a central opening.

In some embodiments, the at least one vent element includes a first vent element formed in a rear of the hive body and a second vent element formed in a bottom of the hive body. In some embodiments, the inner portion of each of the plurality of hexagonal frame members has a triangular cross-section. In some embodiments, each of the plurality of openings may be in the form of an elongated slot extend along a portion of at least one of the six sides of each inner frame. In some embodiments, a back of the hive body defines an observation window. The observation window may include one or both of a mesh material or a solid transparent material. The hexagonal beehive may further include an observation window cover that is engageable with the observation window to obstruct the observation window. In some embodiments, each of the plurality of hexagonal frame members may be spaced apart from an adjacent one of the plurality of hexagonal frame members by between about 0.1125 and 0.5 inches. In some embodiments, the at least one vent element may include a vent element positioned proximate a top of the back of the hive body. In some embodiments, the hexagonal beehive may also include at least one vent cover that is configured to be removably secured with each of the at least one vent element to seal the hexagonal beehive.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A is a front right isometric view of a beehive according to embodiments of the invention.

FIG. 1B is a front left isometric view of a beehive according to embodiments of the invention.

FIG. 1C is a rear isometric view of a beehive according to embodiments of the invention.

FIG. 2A is a front view of a beehive according to embodiments of the invention.

FIG. 2B is a rear view of a beehive according to embodiments of the invention.

FIG. 3 is a rear view of a beehive according to embodiments of the invention.

FIG. 4 depicts a rain overhang of a beehive according to embodiments of the invention.

FIG. 4A depicts a sectional view of the rain overhang of FIG. 4 according to embodiments of the invention.

FIG. 5 illustrates an interface of a front panel of a beehive according to embodiments of the invention.

FIG. 6A is a front isometric view of a beehive according to embodiments of the invention.

FIG. 6B is a side cross-sectional view of the beehive of FIG. 6A according to embodiments of the invention.

FIG. 7A is a top view of a lower vent element of a beehive according to embodiments of the invention.

FIG. 7B is a side cross-sectional view of the lower vent element of FIG. 7A according to embodiments of the invention.

FIG. 7C is a rear cross-sectional view of the lower vent element of FIG. 7A according to embodiments of the invention.

FIG. 8A is a front view of a hexagonal frame member according to embodiments of the invention.

FIG. 8B is a front view of a hexagonal frame member according to embodiments of the invention.

FIG. 8C is a front view of a hexagonal frame member according to embodiments of the invention.

FIG. 9A is a cross-sectional view of a hexagonal frame member according to embodiments of the invention.

FIG. 9B is a cross-sectional view of a hexagonal frame member according to embodiments of the invention.

FIG. 9C is a cross-sectional view of a hexagonal frame member according to embodiments of the invention.

FIG. 10 is an isometric view of a number of hexagonal frame members according to embodiments of the invention.

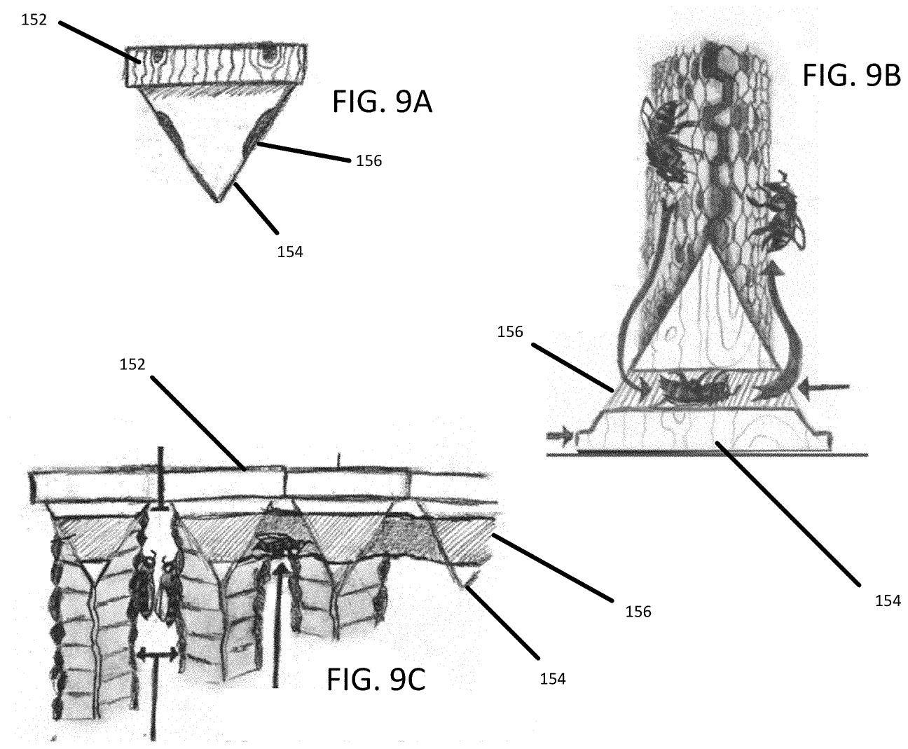

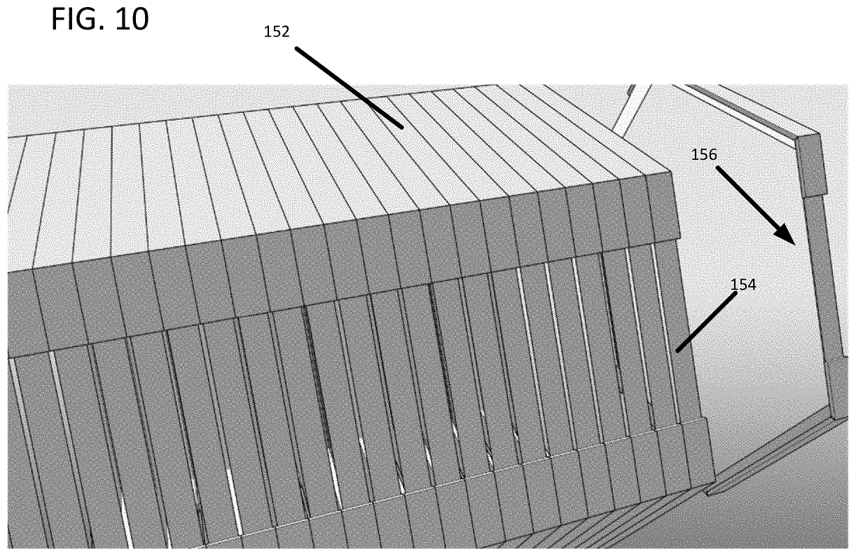

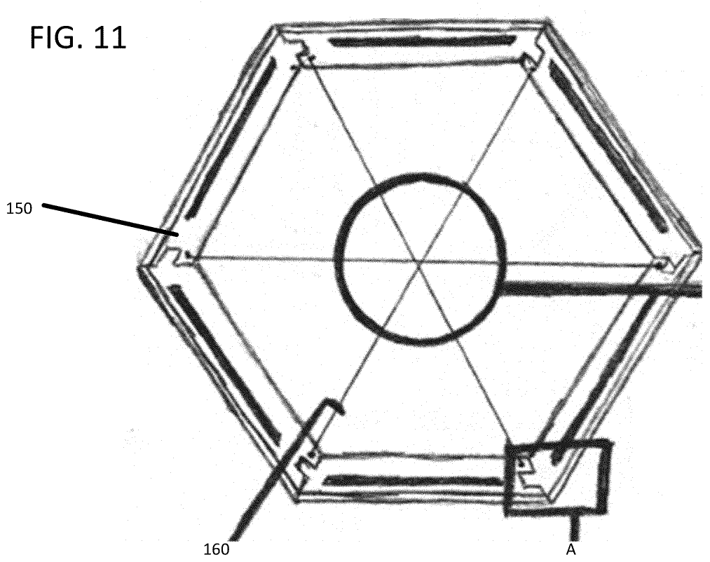

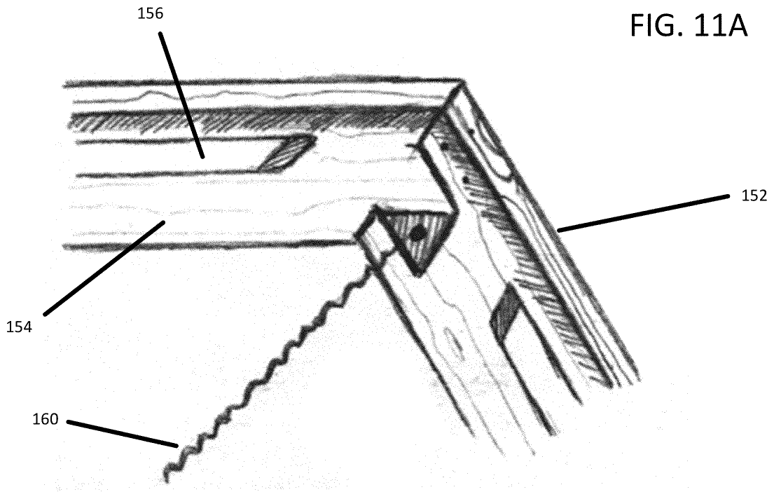

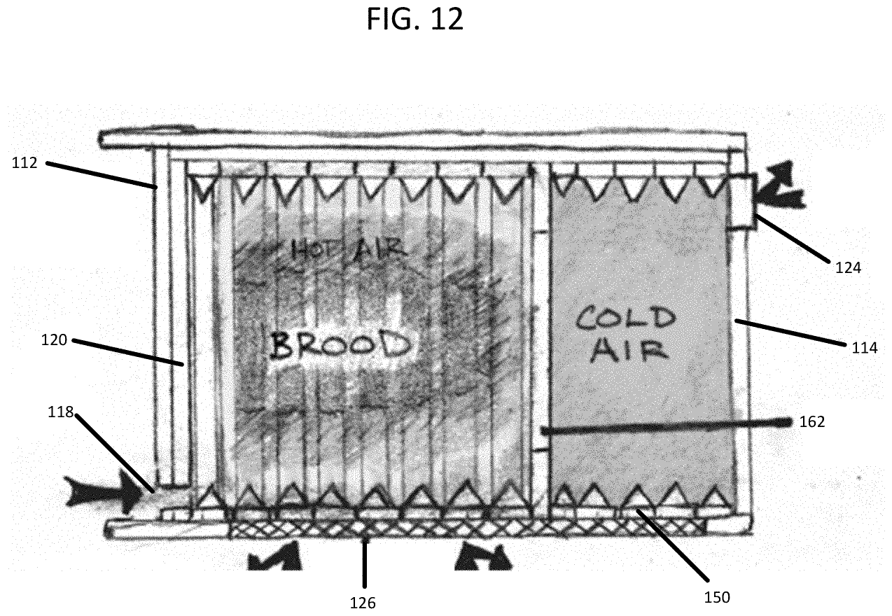

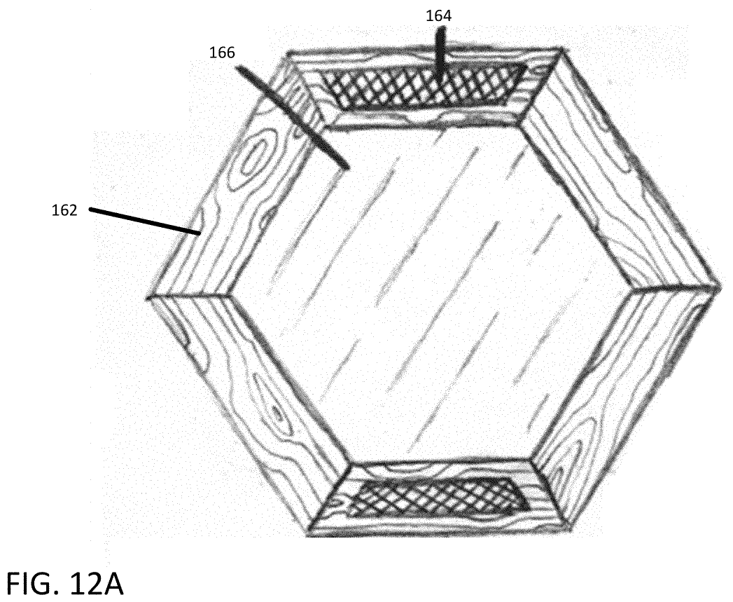

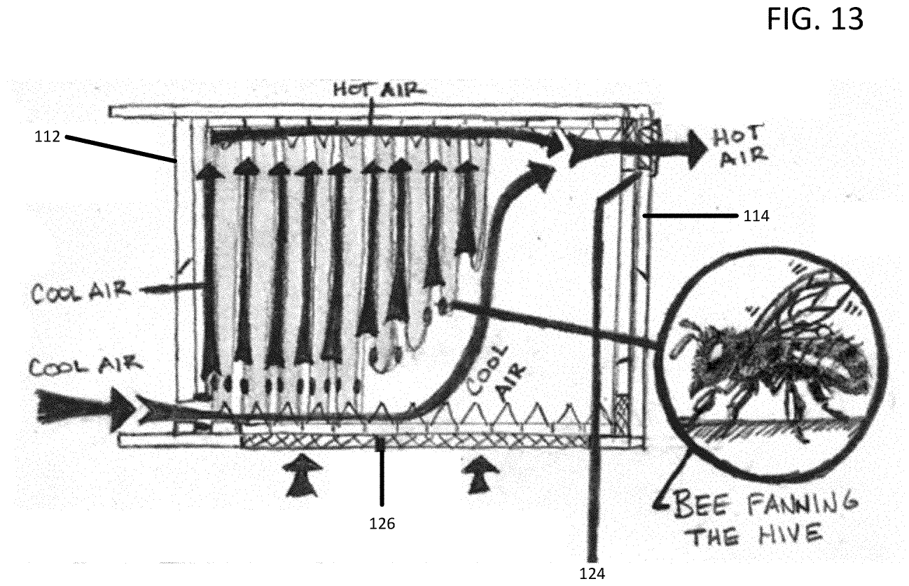

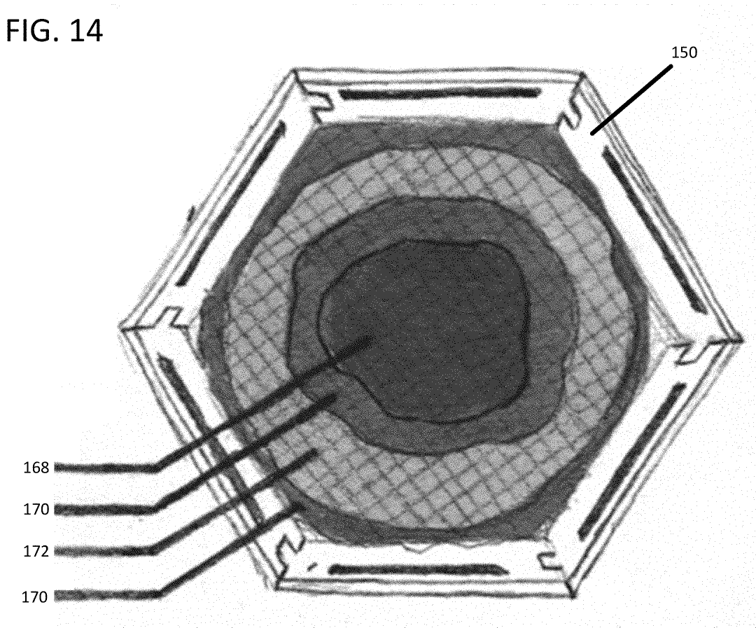

FIG. 9C is a cross-sectional view of a hexagonal frame member according to embodiments of the invention.

FIG. 11 illustrates a support wire according to embodiments of the invention.

FIG. 11A illustrates a sectional view of the support wire of FIG. 11 according to embodiments of the invention.

FIG. 11 illustrates a support wire according to embodiments of the invention.

FIG. 12 illustrates a false back according to embodiments of the invention.

FIG. 12A illustrates a false back according to embodiments of the invention.

FIG. 13 illustrates a ventilation pattern according to embodiments of the invention.

FIG. 14 illustrates a brood pattern according to embodiments of the invention.

FIG. 15 illustrates a honeycomb construction according to embodiments of the invention.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments of the present invention are directed to beehive designs that provide stronger frames for supporting the formation of honeycomb within the beehive, as well as frames that are more suitable to resisting the forces experienced during a centrifuge process that is used to extract honey from the honeycomb. Embodiments also are directed to beehive designs that encourage a more efficient brood pattern that maintains the brood closer to its food source than in conventional hive designs. Embodiments also seek to provide improved ventilation and insulation of the hive to help the bees regulate hive temperature throughout the year.

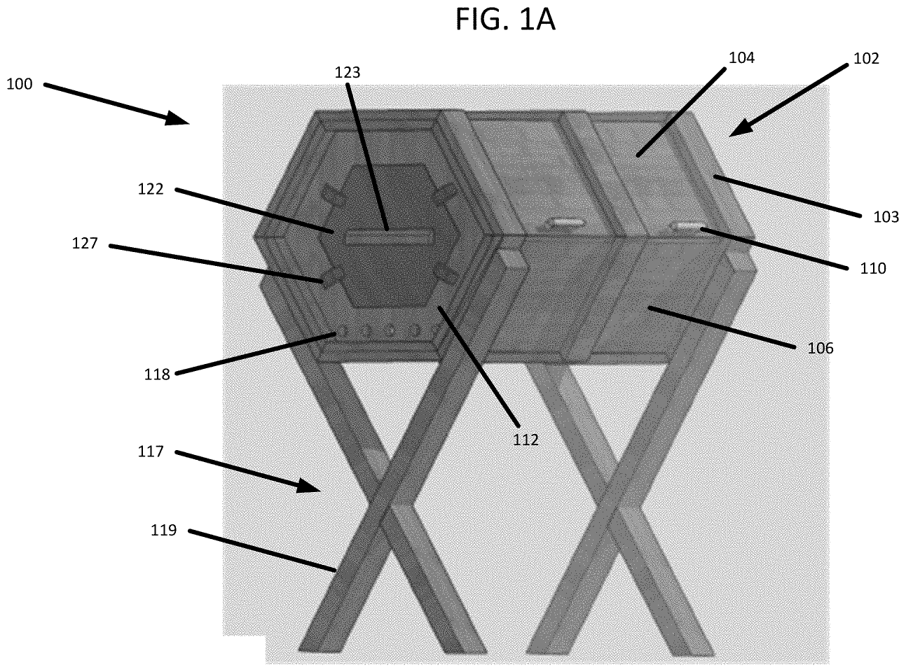

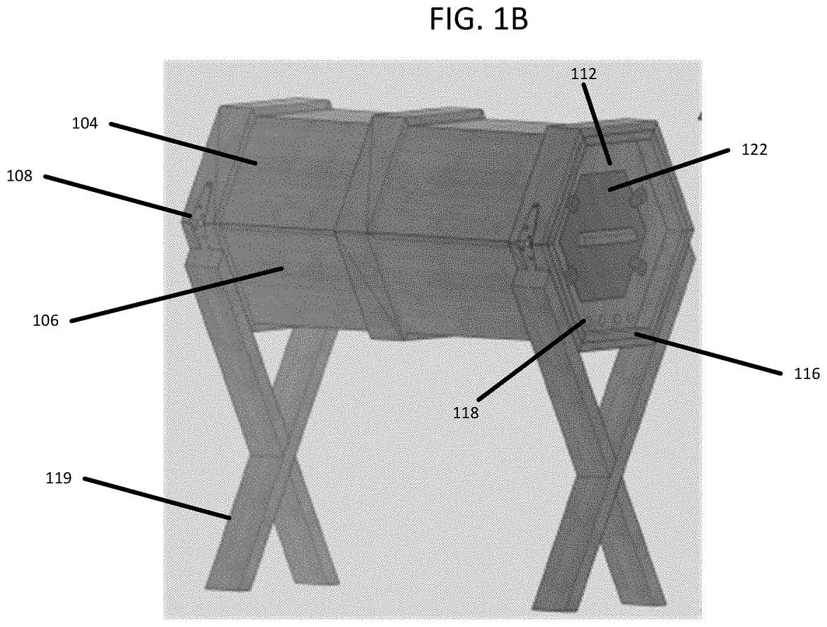

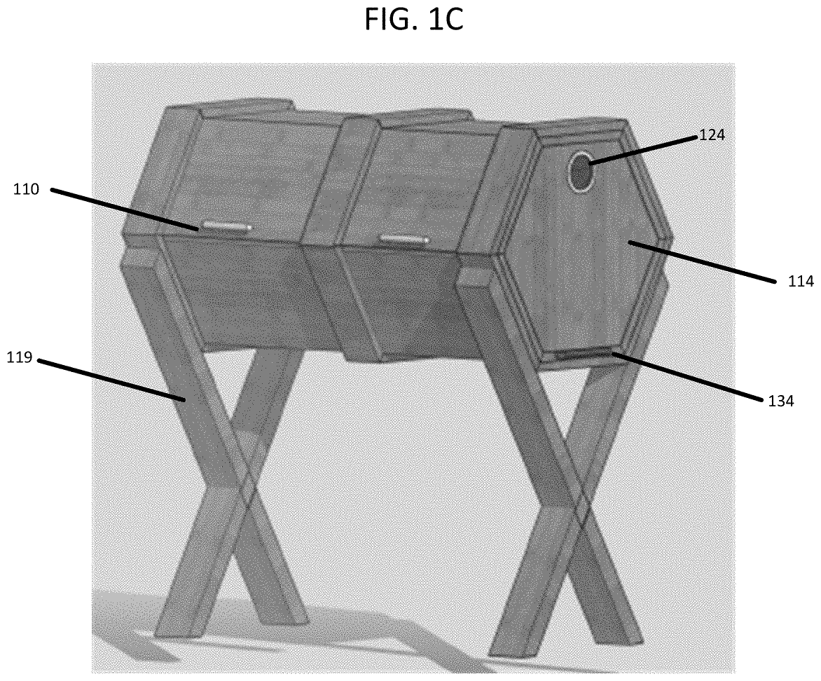

Turning now to FIGS. 1A-1C, one embodiment of a beehive 100 is illustrated. Beehive 100 includes a hive body 102 having a hexagonal cross-section (although other embodiments may incorporate other shapes, such as circles, rectangles, etc.). While often being formed from wood, it will be appreciated that other materials such as plastics, metals, and/or other synthetic and/or natural materials may be utilized. The hive body 102 is separable and includes a top portion 104 and a bottom portion 106 that, when coupled together, define an open interior of the beehive 100. The top portion 104 may be moved relative to the bottom portion 106 to access the open interior. As just one example, the top portion 104 and the bottom portion 106 may be coupled together using a hinge 108 that allows the top portion 104 to be pivoted relative to the bottom portion 106. In other embodiments, the top portion 104 and the bottom portion 106 may be coupled using other mechanism, such as clamps, snaps, meshing alignment/securement features, and the like. In yet other embodiments, the top portion 104 may be sized and shaped to rest atop the bottom portion 106 without any coupling mechanisms. In some embodiments, the hive body 102 may have support members 103 that extend around all or part of the hive body 102 and provide additional strength, while allowing the side walls of the hive body 102 to be formed from thinner material.

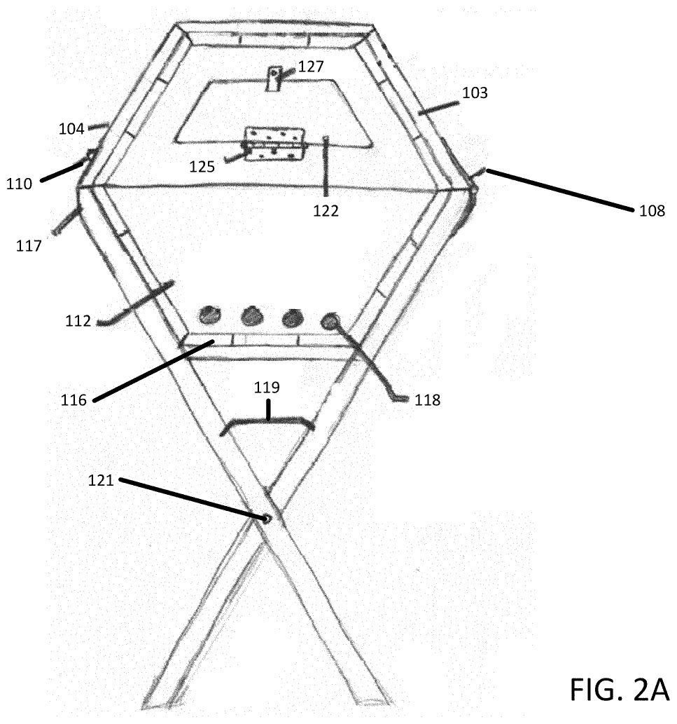

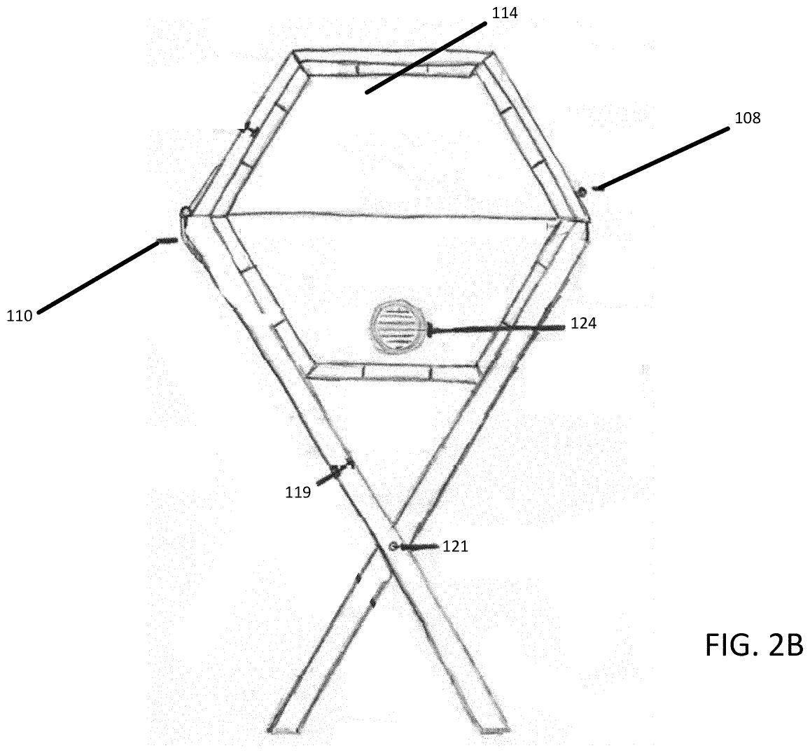

As best illustrated in FIGS. 2A and 2b, for hexagonal beehive 100 designs the top portion 104 may include a topmost side 105, an upper right side 107, and an upper left side 109. The lower portion 106 may include a lowermost side 111, a lower right side 113, and a lower left side 115. In some embodiments, the top portion 104 and bottom portion 106 may each be formed form a single piece of material, while in other embodiments each of the top portion 104 and the bottom portion 106 may be formed from multiple pieces of material. For example, each side of the hive body 102 may be formed from a separate piece of material and then coupled with other pieces to form the top portion 104 and/or bottom portion 106. As just one example, the various pieces may be joined by adhesive, fasteners, mechanical mating features, and/or other known coupling techniques.

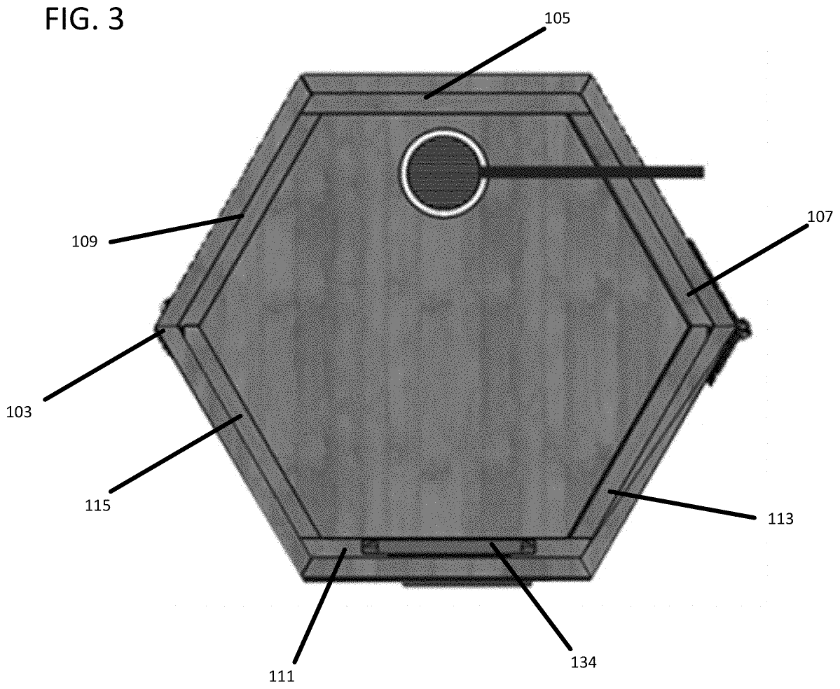

In some embodiments, the hexagonal hive body 102 may be formed such that each of the six sides of the hive body 102 is formed from a different board or other piece of material. For example, topmost side 105, upper right side 107, upper left side 109, lowermost side 111, lower right side 113, and lower left side 115 may each be a different piece of material, with the various pieces joined to form a hexagonal structure for the hive body 102. To form the hexagonal structure, the edges of each of the sides may be cut at an angle prior to mating the sides together. In some embodiments, each side may have the same angled cut at each edge, such as a 60 degree cut. In such embodiments, the sides may be identical trapezoidal shapes that may be interchangeable with one another when constructing the hive body 102. However, in other embodiments, rather than using identical board shapes, a combination of board shapes may be used. As just one example, a combination of boards having trapezoidal and parallelogram cross-sections may be used to construct the hive body 102, such as illustrated in FIG. 3. For example, as shown here, the topmost side 105 and lowermost side 111 may be formed from boards having trapezoidal cross-sections, while upper right side 107, upper left side 109, lower right side 113, and lower left side 115 may be formed from boards having parallelogram cross-sections. Such designs may be particularly useful especially in combination with support members 103 that encompass the hive body 102, as these support members 103 act as an exoskeleton for provided support. The flat surfaces on the top of lowermost side 111 provide greater surface area for coupling to lower right side 113 and lower left side 115 to provide greater structural integrity and to help prevent debris and water ingression into the beehive 100.

In some embodiments, the top portion 104 may include a handle 110, which may be used to move the top portion 104 relative to the bottom portion 106. The handle 110 may be positioned anywhere on the top portion 104, such as on a topmost surface of the top portion 104, which may allow the top portion 104 to be lifted off of the bottom portion 106 in a manner similar to a pot lid. In other embodiments, such as those in which top portion 104 and bottom portion 106 are coupled using one or more hinges 108, the handle 110 may be positioned on a side of the top portion 104 opposite the one or more hinges 108 to assist in pivoting the top portion 104 relative to the bottom portion 106. For example, the handle 110 may extend along an upper right or upper left side of the top portion 104. In some embodiments, multiple handles 110 may be provided at various positions of the top portion 104. For example, in some embodiments, multiple handles 110 may be spaced apart along a length of the top portion 104. In other embodiments, one elongate handle 110 may be provided that extends along all or a substantial (more than 50%, 60%, 70%, 80%, 90%, etc.) portion of the length of the hive body 102.

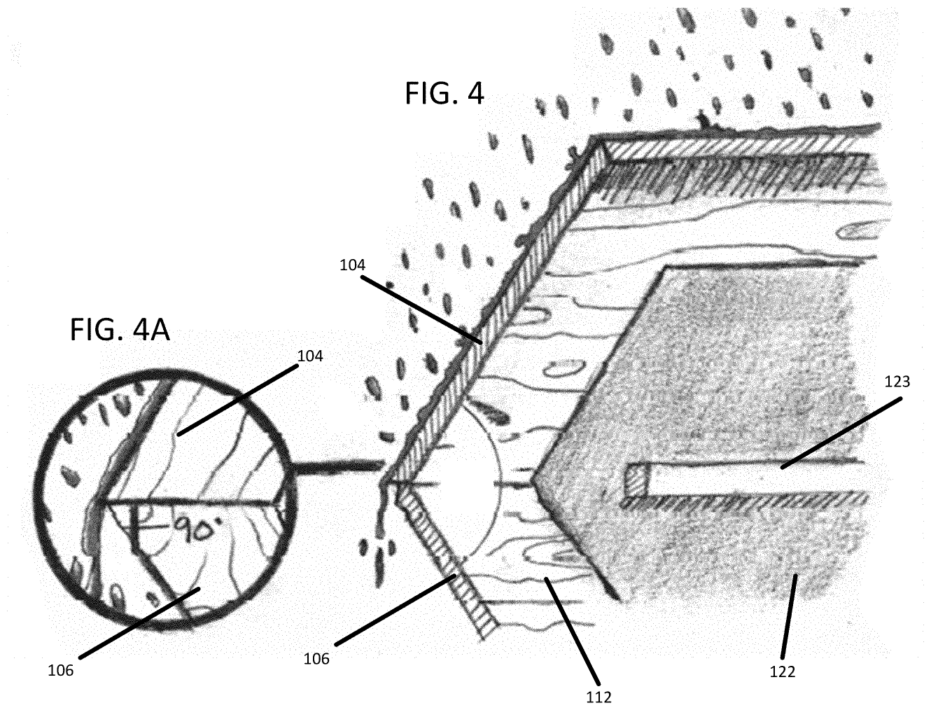

In some embodiments, the top portion 104 is designed to sit atop the bottom portion 106 with a slight overhang. This overhang of the top portion 104 prevents rain from entering the beehive 100 at the joint formed between the top portion 104 and the bottom portion 106. In some embodiments, to form the overhang, the top portion 104 may be designed to be slightly larger than the bottom portion 106 such that an outer edge of the top portion 104 extends beyond an outer edge of the bottom portion 106. In other embodiments, the top portion 104 and the bottom portion 106 may be generally the same size, and formed such that angled edges of each of the top portion 104 and the bottom portion 106 join to close the hive body 102. For example, in a hexagonal design, joining edges of the top portion 104 and the bottom portion 106 may be formed with approximately 60 degree angles such that when joined together, the hexagon has 120 degree interior angles. As illustrated in FIGS. 4A and 4B, the extreme lateral edge of the bottom portion 106 may be modified to cut off a portion of the tip (such as at a 90 degree angle relative to a top surface of the bottom portion 106, although other angles are possible) of the extreme lateral edge such that the extreme lateral edge of the top portion 104 extends beyond the modified tip of the bottom portion 106. In this manner, a lower edge of the top portion 104 of the hive body 102 extends beyond an upper edge of the bottom portion 106 of the hive body 102.

In some embodiments, the beehive 100 may include a base 117. Base 117 may be permanently affixed to the hive body 102 and/or may be removably coupled with the hive body 102. In yet other embodiments, the hive body 102 may be configured to rest atop the base 117 without any coupling mechanisms. Base 117 may include a number of legs 119 that extend downward from the hive body 102. In some embodiments, the legs 119 may be generally vertical, while in other embodiments the legs 119 may be angled outward such as best shown in FIGS. 1A-1C. In such embodiments a portion of the legs 119 may extend upward alongside a portion of the hive body 102 and may form a cradle structure in which the hive body 102 may rest. In some embodiments, the legs 119 may be at fixed heights and/or angles, while in other embodiments pivot points 121 and/or height adjustment mechanisms may be used to provide an adjustable base 117. In some embodiments, rather than including legs 119, base 117 may include any other structure that supports the hive body 102 above a surface (such as the ground, floor, table, counter, etc.).

The hive body 102 may also include a front panel 112 and a back panel 114 that extend between the top portion 104 and the bottom portion 106 and serve to close openings formed proximate opposing ends of the top portion 104 and the bottom portion 106. Together, the top portion 104, bottom portion 106, front panel 112, and back panel 114 define the outer limits of the open interior. In some embodiments, the front panel 112 and/or back panel 114 may be single pieces of material, while in other embodiments the front panel 112 and/or back panel 114 may be formed from multiple sections. For example, the front panel 112 and/or back panel 114 may be in two or more pieces, such as left and right halves or top and bottom halves, although any number of pieces are possible. Oftentimes, the front panel 112 and/or the back panel 114 may be inset from the extreme ends of the top portion 104 and the bottom portion 106 such as seen in FIGS. 1A-1C. This allows an exposed interior surface of the bottom portion 106 to form a landing deck 116 on which bees may land outside an entrance of the beehive 110. The landing deck 116 may also provide the bees an area in which they can defend against invasive species.

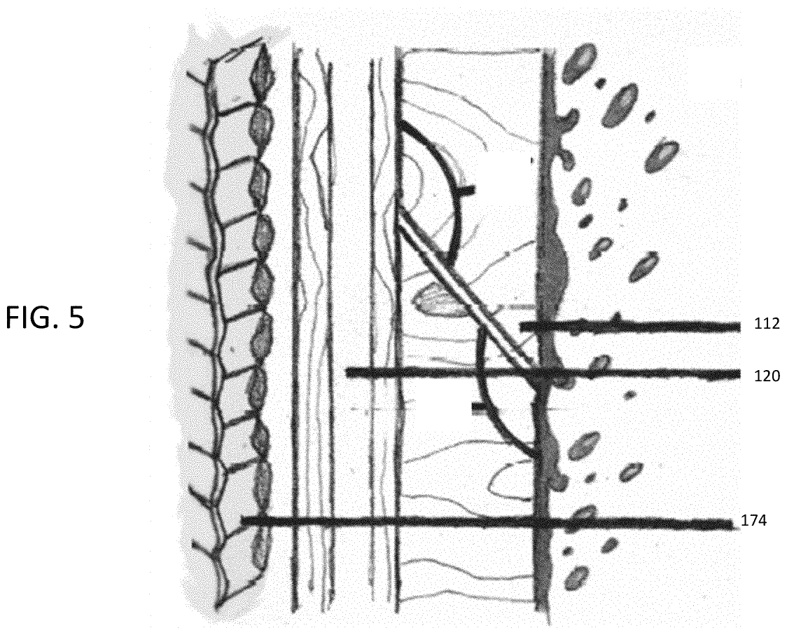

In embodiments in which the front panel 112 and/or back panel 114 are formed separately from the top portion 104 and/or bottom portion 106, the front panel 112 and/or back panel 114 may be joined with the top portion 104 and/or bottom portion 106 using angled cuts that help keep water from getting into the beehive 100. For example, in some embodiments, each of the front panel 112 and/or back panel 114 may have edges that interface with the top portion 104 and/or bottom portion 106 at an angle as best illustrated in FIG. 5. For example, the angled connection may include an inward portion that slopes upward toward an interior of the beehive 100. By forming such an angled interface between the components rain is prevented from entering the beehive 100. In some embodiments, the top portion 104 and/or bottom portion 106 may include an angled groove that is configured to receive an angled edge of the front panel 112 and/or back panel 114 in the manner described above. In some embodiments, any of the outer joints of the hive body 102 may also include one or more resilient sealing members, such as gaskets that help further prevent water and other debris from getting into the beehive 100.

In some embodiments, rather than being separately removable components the front panel 112 and/or back panel 114 may be formed as part of the top portion 104 and/or bottom portion 106 of the hive body 102. As just one example, an entirety of the front panel 112 and/or back panel 114 may be included on the top portion 1004 and/or bottom portion 106. In other embodiments, a portion, such as half, of the front panel 112 and/or back panel 114 may be formed as port of the top portion 104 and/or bottom portion 106.

As best illustrated in FIG. 2A, the front panel 112 may define one or more entrance openings 116 that allow bees to enter and exit the beehive 100. For example, in some embodiments, an array of entrance openings 118 may extend through a face of the front panel 112. As illustrated, four circular entrance openings 118 are positioned near a bottom edge of the front panel 112. As illustrated, each of the entrance openings 118 has a diameter of approximately ⅞ inches, which allows the entrance openings 118 to be sealed using wine corks, although other sizes of entrance openings 118 may be utilized. To cover the entrance openings 118, objects such as cork, rubber, and/or other compressible objects having slightly larger diameters than the entrance openings 118 may be inserted into the entrance openings 118. In other embodiments, a hinged flap, slidable cover, and/or other object may be positioned over one or more of the entrance openings 118 to close the entrance of the beehive 100.

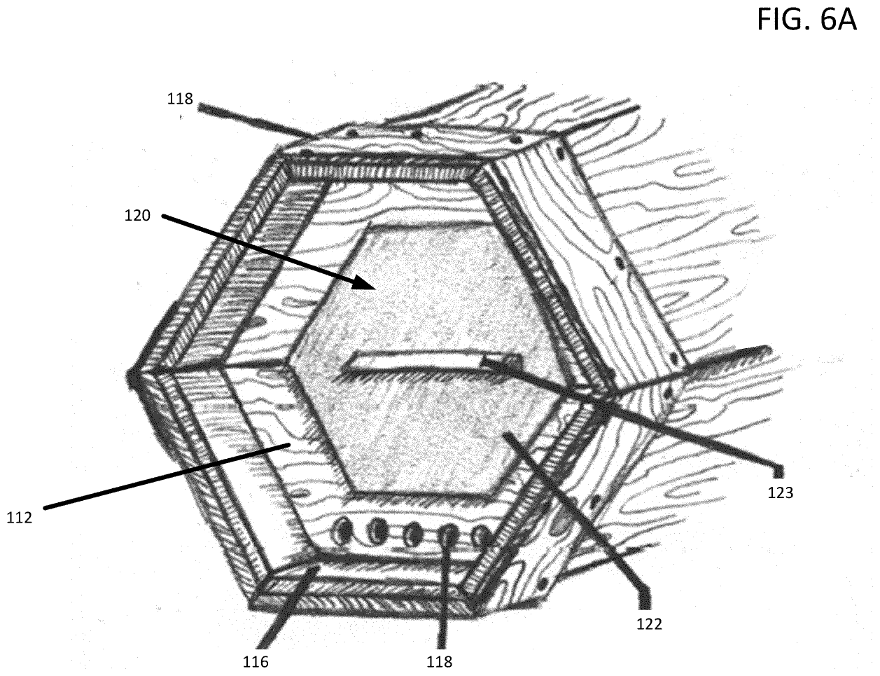

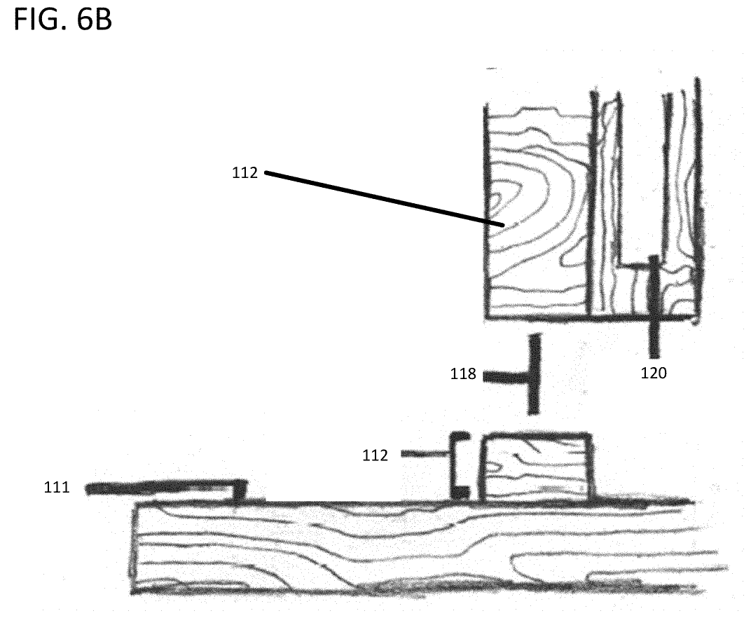

In some embodiments, the entrance openings 118 are positioned a distance above the landing deck 116. For example, the entrance openings 118 may be positioned at least about ¼ inch above the landing deck 116, although other heights (both lower and higher) are possible in some embodiments. By elevating the entrance openings 118 relative to the landing deck 116 a portion of the front panel 112 that is disposed between the landing deck 116 and a lower edge of the entrance openings 118 is able to serve as a pest barrier that may prevent small parasites, as well as water, from entering the beehive 100 as seen in FIGS. 6A and 6B.

While shown in a linear pattern, it will be appreciated that an array of entrance openings 118 may be formed in any pattern about the front panel 112. Additionally, non-circular openings (rectangular, hexagonal, triangular, etc.) may be provided instead of, or in addition to circular openings. Additionally, in some embodiments some or all of the entrance openings 118 may have different sizes. Oftentimes, the entrance openings 118 may be positioned on a lower portion of the front panel 112 such that cool air can be drawn into a bottom of the interior of the hive body 102 to push out hot air.

In some embodiments, the front panel 112 and/or back panel 114 may define one or more larger observation windows 120. The observation window 120 may be formed with a mesh screen and/or a transparent panel that allows a user to view the interior of the beehive 100. The observation window 120 may be embedded or otherwise formed within the front panel 112 and/or back panel 114. In other embodiments, the observation window 120 may be posited adjacent and/or coupled with an interior and/or exterior surface of the front panel 112 and/or back panel 114. In other embodiments, the observation window 120 may be entirely open, such that the interior of the beehive 100 may be access via the observation window 120. The observation window 120 may be positioned at any part of the front panel 112 and may have any size or shape. As illustrated in FIGS. 1A, 1B, and 6A, the observation window 120 is hexagonal in shape and is centered on the front panel 112, taking up a significant portion of the front panel 112 that is inward of the entrance openings 118. In other embodiments, the observation window 120 may in formed entirely or primarily in only a single half of the front panel 112, such as a top, bottom, right, or left half. For example, as shown in FIG. 2A, the observation window 120 may be formed entirely on a top half of the front panel 112. Such designs may be particularly preferable in embodiments in which an upper portion of the front panel 112 is formed with the top portion 104 of the hive body 102 and a lower portion of the front panel 112 is formed with a bottom portion 106 of the hive body 102.

The observation window 120 may include an observation window cover 122 that may be movably coupled with the front panel 112 such that the observation window 120 may be covered up when not being accessed. In some embodiments, the observation window cover 122 may be coupled with the front panel 112 using a hinge 125, such as seen in FIG. 2A. In such embodiments, the observation window cover 122 may be pivoted between a covered and an access position using the hinge 125. In some embodiments, a lock mechanism 127 may be used to secure the observation window cover 122 over the observation window 120. For example, the may include a lever that is pivotally coupled with the front panel 112. The lever may be rotated about a pivot point between a locked position in which the lever obstructs the removal (or insertion) of the observation window cover 122 and an access position in which the lever does not obstruct the removal or insertion of the observation window cover 122. Other lock mechanisms, such as latches, hooks, clasps, magnets, fasteners, and/or other securement mechanisms may also be utilized to secure the observation window over 122 may be used.

In other embodiments, the observation window cover 122 may be configured to be slidably coupled with the front panel 112. For example a track may be provided on the front panel 112 about at least a portion of the observation window 120. The observation window cover 122 may be configured to engage with and be slid into the track to secure the observation window cover into position over the observation window 120. The observation window cover 122 may be slid completely out of engagement with the track such that the observation window cover 122 may be completely removed from the front panel 112 and/or the track may be sufficiently large such that the observation window cover 122 may be retained on the front panel while still being slid far enough to allow access to the observation window 120.

In some embodiments, the observation window cover 122 may be formed to have a size that substantially matches that of the observation window 120. In such embodiments, the observation window cover 122 may be inserted into the observation window 120 with the observation window 120 is not being accessed such as shown in FIGS. 1A, 1B, and 6A. The observation window cover 122 may be secured using a snap fit, friction fit, and/or other securement mechanisms. Oftentimes, the observation window cover 122 may include a handle 123 that is graspable by a user to manipulate the observation window cover 122 between the locked position and the access position.

A rear of the beehive 100, such as back panel 114, may define at least one air vent 124. Any number of air vents 124 may be included and may have any size, shape, and may be at any position on the back panel 114. Oftentimes, the air vent 124 may be positioned at a top of the back panel 114 as shown in FIG. 1C. This allows hot air to more easily escape from the beehive 100 along a top interior surface or ceiling of the beehive 100. For example, in the warmer seasons and/or climates, bees will oftentimes flap their wings to cool the beehive 100. In doing so, cooler air is drawn into the beehive 100 (such as through the entrance openings 118 and/or from lower vents such as vent element 126 described below) and hot air may be forced out through the air vent 124 as shown in FIG. 13. In colder seasons and/or climates, all the air vents (air vent 124, vent element 126, entrance openings 118, etc.) may be closed. The bees will cluster around the brood (baby bees) in the center of the beehive 100 to create a strong heat source and will use wax to seal and block unwanted cold airflow to help insulate the beehive 100 to keep the colony warm for surviving the colder temperatures. Additionally, the large corner angles associated with the hexagonal design of the beehive 100 prevent air from getting trapped in the corners.

In some embodiments, the air vent 124 may include a number of slats that cover a portion of an opening of the air vent 124. In other embodiments, the air vent 124 may include a mesh screen that allows air to pass through the air vent 124 while preventing insects and/or debris from entering the beehive 100. The air vent 124 (along with other vents and/or openings in the body 102) may provide an inlet and/or outlet that enable air to circulate through the beehive 110. In some embodiments, the air vent 124 may include a removable cover (which may be similar in structure to the observation window cover 122) that may be used to seal the air vent 124. This may be particularly useful in winter to seal the beehive 100 and allow heat to be trapped within the beehive 100 to keep the bee colony warm.

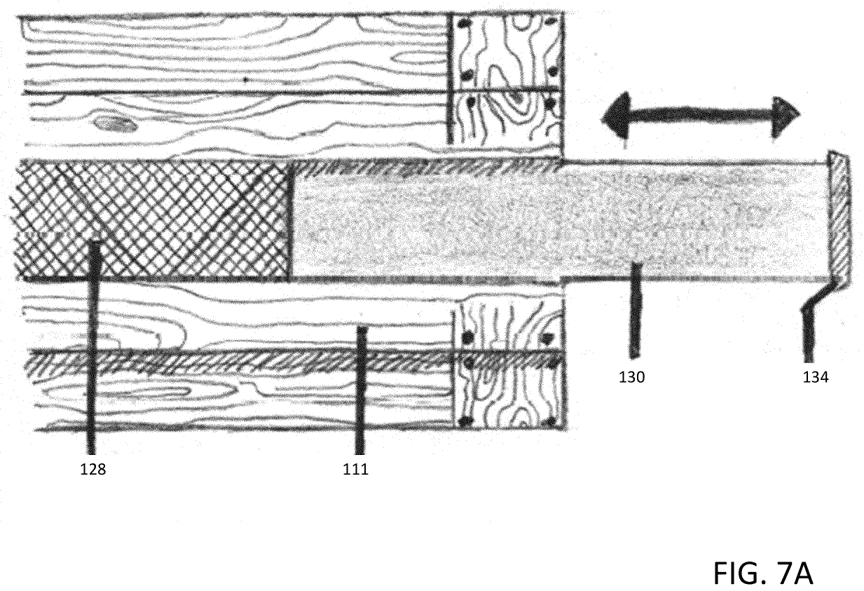

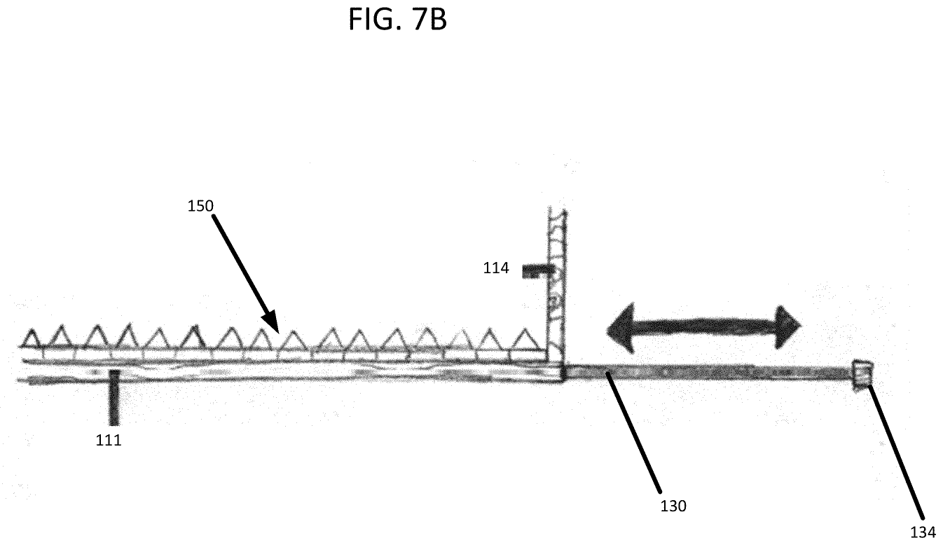

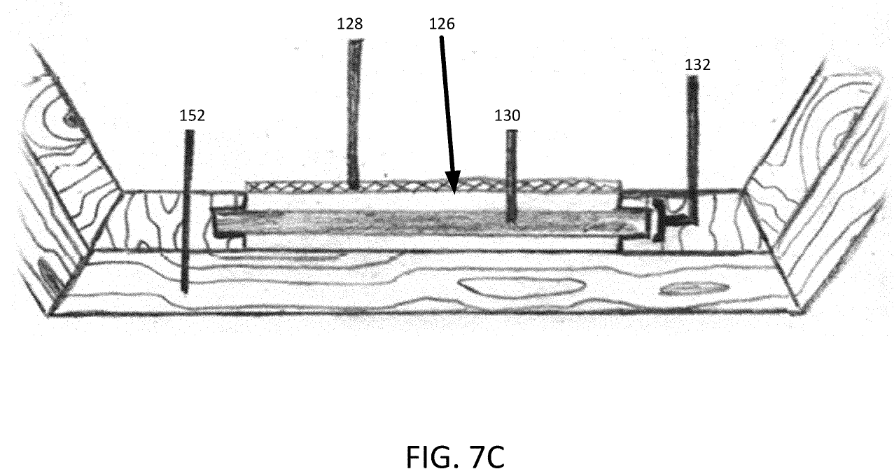

In some embodiments, a bottom of the hive body 102 may define a vent element 126 as shown in FIGS. 7A-7C. For example, a portion of the bottom of the hive body 102 may define one or more openings that allow air to be vented. Each opening may include a mesh insert 128 that that spans the opening and prevents pests and debris from entering the beehive 100 while keeping the bees in the beehive 100. The mesh insert 128 may be formed of stainless steel and/or other oxidation-resistant material. In some embodiments, a removable vent panel 130 may be provided that allows the vent element 126 to be closed. For example, in some embodiments, the vent panel 130 may be configured to slide into engagement with the bottom of the hive body 102. As best illustrated in FIG. 7C, the vent panel 130 may be sized and shaped to be slidable within a vent channel 132 that is positioned above or below the mesh insert 128. The vent panel 130 may also include a handle 134 that allows a user to easily grasp the vent panel 130 to insert and/or remove the vent panel 130 from the vent channel 132 to close and/or open the vent element 126. Handle 134 and/or vent panel 130 may be accessible from the front and/or back side of the hive body 102. In such embodiments, the vent panel 130 may be slightly wider than an opening of the vent element 126 such that when inserted within the vent channel 132, the vent panel 130 extends beyond an outer edge of the opening of the vent element 126 to completely close off the vent element 126. In some embodiments, the vent panel 130 and/or vent channel 132 may also include one or more resilient sealing members, such as, but not limited to rubber gaskets so as to provide a tighter seal when the vent panel 130 is engaged within the vent channel 132.

Oftentimes, the vent panel 130 is fitted within the vent channel 132 during the winter to help keep warm air within the beehive 100 from escaping to keep the bees housed within warm. The vent panel 130 may be removed from the vent channel 132 in the summer to help increase air circulation within the beehive 100 to cool the beehive 100.

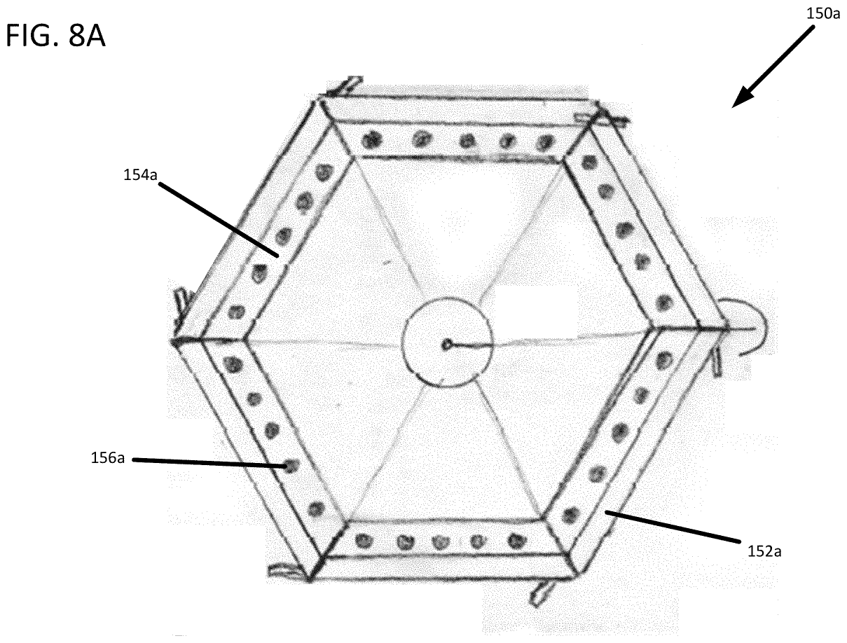

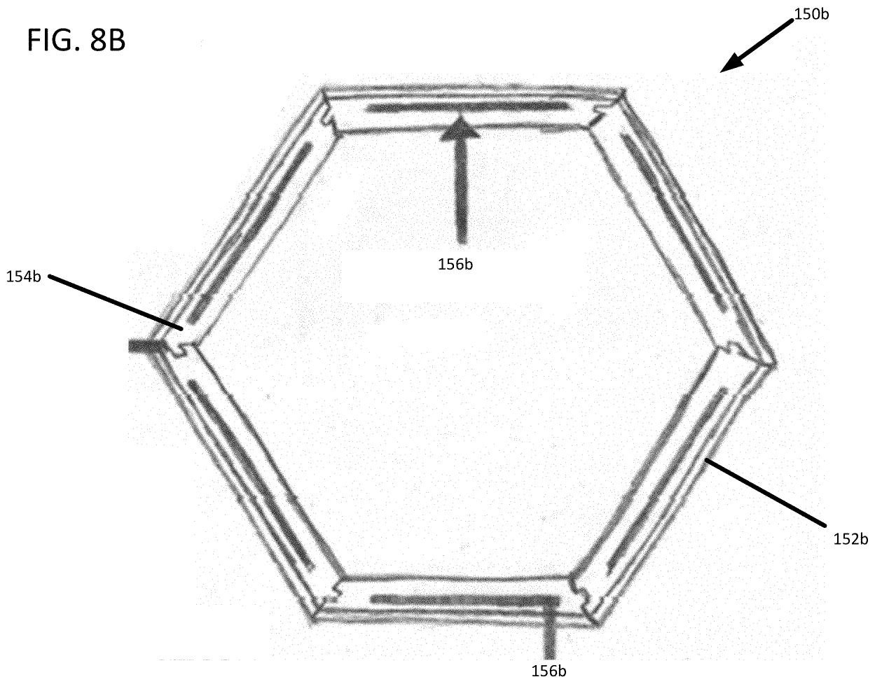

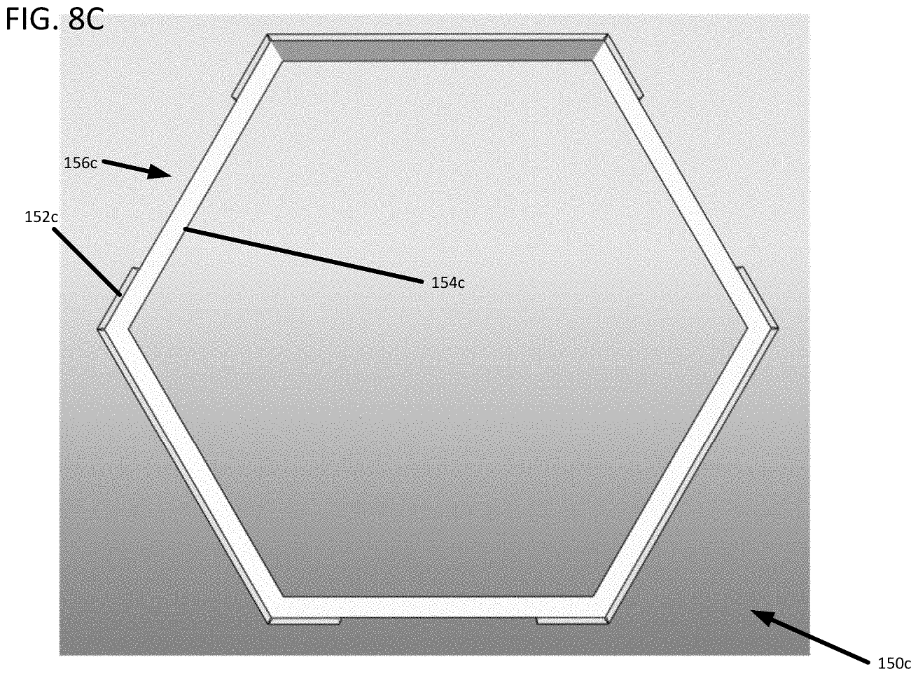

As seen in FIGS. 8A-8C, the beehive 100 may also include a number of hexagonal frame members 150 that may be inserted within the interior of the beehive 100. While disclosed as being hexagonal, it will be appreciated that other shapes of frame members may be utilized, oftentimes with the individual ones of the frame members being sized and shaped to substantially match interior dimensions (size and profile shape, etc.) of the interior of the beehive 100. For example, if the interior of the beehive 100 is circular or rectangular in shape, the frame members will likely be circular or rectangular as well. Typically the hexagonal frame members 150 a removable from the interior of the beehive 100. This allows a number and position of the hexagonal frame members 150 to be customized to meet the needs of a particular beehive 100. Additionally, the hexagonal frame members 150 can then be removed and spun in a centrifuge to extract honey. Due to this, the hexagonal frame members 150 must be formed from strong, rigid materials, such as, but not limited to wood.

Each of the hexagonal frame members 150 may include an outer frame 152 and an inner frame 154. In some embodiments, the outer frame 152 and the inner frame 154 may be formed integral with one another from a single piece of material, while in other embodiments the outer frame 152 and inner frame 154 may be formed separately and later joined to form each of the hexagonal frame members 150. Similar to the sides of hive body 102, in some embodiments, the sides of each hexagonal frame member 150 may be formed from separate pieces of material that are adhered and/or fastened together (such as using tongue and groove connections, fasteners, and/or other mechanical couplings). In some embodiments, multiple sides may be formed from a single piece of material, while in other embodiments the entire hexagonal frame member 150 may be formed from a single piece of material.

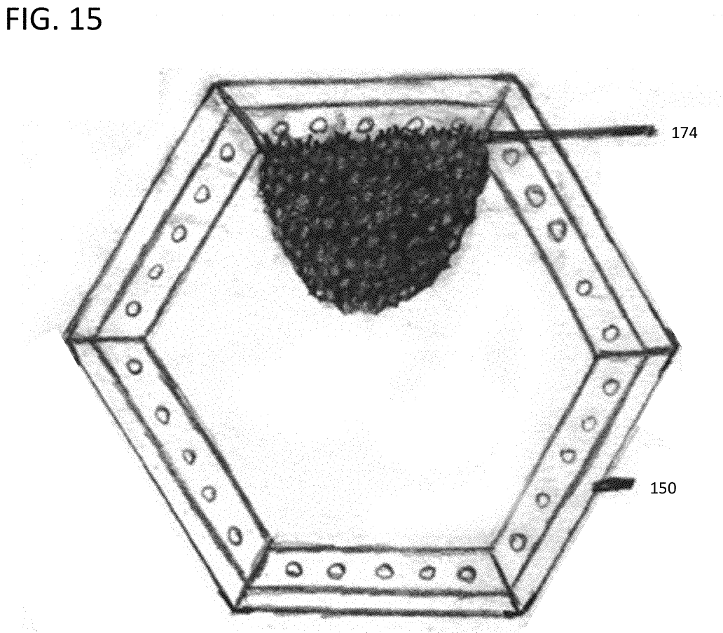

The outer frame 152 may have a first thickness and the inner frame 154 has a second thickness that is smaller than the first thickness. This allows inner frames 154 of adjacent ones of the hexagonal frame members 150 are spaced apart from one another as best seen in FIGS. 9C and 10, even if faces of adjacent outer frames 152 are in contact with one another. For example, a thickness of the inner frame 154 may be constant and have a rectangular cross-section with a thickness that is smaller than that of the outer frame 152. In other embodiments, the thickness of the inner frame 154 may taper from a larger thickness near the outer frame 152 to a smaller thickness. The taper may be constant and/or variable. A constant taper may provide the inner frame 154 with a triangular cross-section as illustrated in FIGS. 9A-9C. For example, in some embodiments, a cross-section of the inner frame 154 may be approximately shaped like an equilateral triangle (or triangle of other dimensions).

In some embodiments, each of the inner frames 154 may define one or more openings 156 or access channels. In some embodiments, the openings 156 extend entirely through a thickness of the respective inner frame 154. Oftentimes, each side of the inner frame 154 may include at least one opening 156. For example, for a hexagonal frame member 150, the inner frame 154 includes six sides, each of which may include at least one opening 156 (although in some embodiments one or more sides may not define any openings). These openings 156 within the inner frame members 154, in conjunction with the gaps formed between adjacent inner frames 154 allows provide an area through which bees may move between adjacent hexagonal frame members 150 as shown in FIG. 9C.

The openings 156 may be used by the bees to create a wax tunnel that the bees may use to survive the winter. For example, in some embodiments, the inner frames 154 of adjacent hexagonal frame members 150 may be positioned between 0.25 and 0.5 inches (commonly about 0.375 inches) from one another. This may be measured at a base of the tapered portion in some embodiments. This spacing provides the bees access to enter the openings 156 to construct wax tunnels within the opening 156. Additionally, such spacing provides room for the bees to move between adjacent combs formed on adjacent hexagonal frame members 150 and eliminated the need to cross-comb.

In some embodiments, the openings 156a may be small openings, such as small, discrete circular (or other shaped) openings 156a that extend along a length of at least one side of the inner frame 154a such as shown in FIG. 8A. In other embodiments, the openings 156b may be elongate channels that extend along a length of one or more sides as shown in FIG. 8B. For example, in some embodiments, each side of the inner frame 154b may define a single elongate opening 156b that extends along a significant portion (such as 25%, 35%, 45%, 50%, 55%, 65%, 75%, 85%, 95%, etc.) of the length of a particular side of the inner frame 154b. In some embodiments, the elongate opening 156b may be centered on the side of the inner frame 154b, while in other embodiments the elongate opening may be offset relative to a center of the side of the inner frame 154b. In some embodiments, multiple elongate openings 156b may be formed on a single side of the inner frame 154b. In some embodiments, an elongate opening 156b may extend into two different sides of the inner frame 154b. For example, an elongate opening 156b may be V-shaped (or other non-linear shape) such that the opening 156b may extend along two or more adjacent angled sides of the inner frame 154b. In some embodiments, the openings 156b may have a thickness of between about 0.125 and 0.375 inches (with about 0.25 inches being common) to provide sufficient room for bees to pass through the openings 156b.

In yet other embodiments, rather than extending through a thickness of the inner frame 154c and/or outer frame 152c, the openings 156c may be formed between an outer edge of each hexagonal frame member 150c and an interior wall of the hive body 102. For example, a portion of the outer frame 152c and/or inner frame 154c may be cut away and/or otherwise formed to have a smaller outer diameter (or similar dimension) than a remaining portion of the outer frame 152c as shown in FIG. 8C. Once the hexagonal frame member 150c is inserted into the hive body 102, an elongated channel or gap is formed between the portion of the outer frame 152c having the smaller outer diameter and an inner wall of the hive body 102. These gaps form the openings 156c. As illustrated, three openings 156c are provided, although any number of gaps on any number of sides of the hexagonal frame members 150c may be used. Additionally, by including an opening 156c on the lower side of the hexagonal frame member 150c, the lower opening 156c may also help aid in ventilation by allowing cool air to be drawn into the interior of the hive body 102 and forcing warmer air out through the rear air vent 124.

In some embodiments, such as shown here, to form openings 156c the hexagonal frame member 150c may include an outer frame 152c that is formed from separate pieces that are adhered, fastened, and/or otherwise secured to the inner frame 154c with spaces formed between the various pieces of outer frame 152c forming the spaces for openings 156c. In such embodiments, a gap between an outer edge of the inner frame 154c and the inner surface of the hive body 102 forms the openings 156c. While illustrated as being formed from multiple pieces, it will be appreciated that in some embodiments the outer frame 152c and/or inner frame 154c may be formed from a single piece of material. Similarly, in some embodiments, the outer frame 152c and inner frame 154c may be both formed from a single piece of material.

Each inner frame 154 defines a central opening 158 that provides a space in which the bees may produce honeycomb and form their brood. Typically, the central opening 158 makes up a significant portion (greater than 50%, 55%, 65%, 75%, 85%, 95%, etc.) of the area of each hexagonal frame member 150 to maximize the area in which the bees may live. This makes it desirable to fabricate the hexagonal frame members 150 from strong materials so as to provide maximum strength with minimal frame material. Materials may include, but are not limited to: wood, metal, plastic, and/or combinations thereof. The inner frame 154 and openings 156 serve as attachment points for the bees to secure the honeycomb to the hexagonal frame member 150.

Beeswax and honeycomb are very fragile, especially in warmer climates. The weakest point of the honeycomb in a filled hexagonal frame member 150 is the exact center of the hexagonal frame member 150/central opening 158. In some embodiments, to provide additional strength to the honeycomb each of the of hexagonal frame members 150 may include one or more wires 160 that extend across at least a portion of the central opening 158 as shown in FIGS. 11 and 11A. Typically, the wires 160 extend through a center of the central opening 158 so as to form halves or wedge-shaped sections within the central opening 158 as shown in FIG. 11 (although in some embodiments one or more of the wires 160 may be offset from the center of the central opening 158. The wires 160 may be formed from metal, plastic (such as fishing line) and/or other synthetic and/or natural material. The wires 160 may be coupled with the outer frame 152 and/or the inner frame 154 of a respective one of the hexagonal frame members 150. For example, as shown in FIG. 11A holes and/or other mounting features may be provided in corners (or other locations) of the hexagonal frame members 150, such as at or near intersection points between the sides of adjacent hexagonal frame members 150. The holes and/or other mounting features provide attachment points for the wires 160. The bees will build the honeycomb directly over the wires 160, with the wires 160 supporting and providing additional strength to the honeycomb.

As shown in FIGS. 12 and 12A, the beehive 100 may include a false back 162 that may be positioned within the interior of the beehive 100 at any location and adjacent any of the hexagonal frame members 150. This allows the false back 162 to effectively alter a size of the interior of the beehive 100, which may be useful to regulate a size of a bee colony within the beehive 100 and/or to adapt a larger beehive 100 for use with smaller and possibly growing colony of bees. For example, a smaller colony of bees may require only the use of a portion of the beehive 100. The false back 162 may be positioned to limit the size of the interior to match the requirements of the colony as illustrated in FIG. 12. As the colony grows, the size of the beehive 100 may need to be expanded. The false back 162 may be moved further back and/or removed to expand the size of the interior to accommodate the growing colony.

The false back 162 may have a similar size and shape as the frame members 150 such that the false back 162 may be slid into and out of the interior of the beehive 100 at any desired position. For example, in many embodiments such as that shown in FIG. 12A, the false back 162 may have an outer periphery that is generally hexagonal such that the false back 162 fits snuggly within an interior of the beehive 100 so as to enclose the bee colony within a desired space of the beehive 100. In some embodiments, the false back 162 may be formed of cedar wood so as to deter invasive insects from entering the beehive 100.

In some embodiments, the false back 162 may have a similar structure as the back panel 114 of the beehive 100. For example, the false back 162 may be generally solid and may, in some embodiments, include one or more vents 164 and/or one or more observation windows 166. As illustrated here, the false back include two vents 164, one at a top of the false back 162 and one at a bottom of the false back 162, however other arrangements and/or numbers of vents 164 are possible. As illustrated, the false back 162 also includes an observation window 166 positioned proximate a center of the false back 162. Oftentimes, the observation window 166 may be formed of Plexiglas or other solid and transparent material. In other embodiments, the observation window 166 may be formed of a mesh screen and/or other porous material that helps increase air circulation within the beehive 100, which may be particularly useful in warmer climates.

Unlike conventional Langstroth beehive frames, the hexagonal frame member 150 (and overall hexagonal hive design) allow the bees to construct comb and organize the colony's elements in a more efficient brood pattern. As illustrated in FIG. 14 the hexagonal design enables an efficient brood pattern in which the brood 168 (baby bees) is centered within the central opening 158 and is surrounded by alternating layers of pollen 170 (source of protein) and honey 172 (source of carbohydrates). This brood pattern reduces the distance between the brood and food sources and helps moderate temperatures within the beehive 100.

Typically, the bees should festoon on a top of the hexagonal frame member 150 as the bees begin to construct honeycomb 174 as shown in FIG. 15. The bees will then build honeycomb downward until the honeycomb 174 is connected to all sides of the hexagonal frame member 150. The bee tunnels formed from openings 156 provide space for the bees to wrap around the comb and connect the honeycomb 174 to all sides of the hexagonal frame member 150. By allowing the honeycomb 174 to be connected on all sides of the hexagonal frame member 150, the honeycomb is easier to extract. In embodiments in which the inner frame 154 is tapered, the point of the inner frame 154 acts as a guide for the bees, as the bees will festoon on the point and draw new comb 174.

The hexagonal frame structure also provides added strength as compared to conventional beehives, as the additional sides of the hexagonal frame members 150 provide greater amounts of material and contact points for the honeycomb to be supported once the honeycomb is attached to all sides of the hexagonal frame members 150.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A hexagonal beehive, comprising
a hive body having a hexagonal cross-section, the hive body comprising a front, a back, a top half, and a bottom half, wherein:
the front comprises a landing deck and defines an entrance opening that is raised above the landing deck;
the rear comprises a first sealable vent element;
the bottom comprises a second sealable vent element; and
the hive body defines an open interior,
a plurality of hexagonal frame members having outer peripheries that are sized and shaped to substantially match inner dimensions of the hive body such that the plurality of hexagonal frame members are positionable within the open interior of the hive body, wherein:
each of the plurality of hexagonal frame members comprises an outer frame having a first thickness and an inner frame having a second thickness that is smaller than the first thickness such that the inner frames of adjacent ones of the plurality of frame members are spaced apart from one another;
each of the plurality of hexagonal frame members comprises a plurality of access channels; and
each inner frame defines a central opening; and
a base configured to support the hive body.

2. The hexagonal beehive of claim 1, wherein:
a lower edge of the top half of the hive body extends beyond an upper edge of the bottom half of the hive body.

3. The hexagonal beehive of claim 1, wherein:
at least some of the plurality of access channels extend into at least two of the sides of the inner frame.

4. The hexagonal beehive of claim 1, wherein:
each of the plurality of hexagonal frame members further comprises a plurality of wires coupled with one or both of the outer frame and the inner frame, each of the plurality of wires extending across at least a portion of the central opening.

5. The hexagonal beehive of claim 1, further comprising:
a false back that is positionable adjacent any of the plurality of hexagonal frame members to regulate a size of a bee colony within the beehive.

6. The hexagonal beehive of claim 5, wherein:
the false back comprises a vent portion.

7. The hexagonal beehive of claim 1, wherein:
one or both of the front and the back define an observation window.

8. The hexagonal beehive of claim 1, wherein:
the top half comprises a handle for moving the top half relative to the bottom half.

9. The hexagonal beehive of claim 1, wherein:
the base comprises legs.

10. The hexagonal beehive of claim 1, wherein:
the inner frame and the outer frame are integral to one another.

11. A hexagonal beehive, comprising:
a hive body having a hexagonal cross-section and defining an open interior, a front of the hive body defining at least one entrance opening, wherein the hive body comprises at least one vent element;
a plurality of hexagonal frame members having outer peripheries that are sized and shaped to substantially match inner dimensions of the hive body such that the plurality of hexagonal frame members are positionable within the open interior of the hive body, wherein:
each of the plurality of hexagonal frame members comprises an outer portion having a first thickness and an inner portion having a second thickness that is smaller than the first thickness such that the inner portions of adjacent ones of the plurality of frame members are spaced apart from one another;
each of the plurality of hexagonal frame members comprises at least one access channel positioned proximate an outer periphery of the hexagonal frame member; and
each inner portion defines a central opening.

12. The hexagonal beehive of claim 11, wherein:
the at least one vent element comprises a first vent element formed in a rear of the hive body and a second vent element formed in a bottom of the hive body.

13. The hexagonal beehive of claim 11, wherein:
the inner portion of each of the plurality of hexagonal frame members comprises a triangular cross-section.

14. The hexagonal beehive of claim 11, wherein:
each of the at least one access channel is an elongated opening extending along a portion of one of the six sides of each hexagonal frame member.

15. The hexagonal beehive of claim 11, wherein:
a back of the hive body defines an observation window.

16. The hexagonal beehive of claim 15, wherein:
the observation window comprises one or both of a mesh material or a solid transparent material.

17. The hexagonal beehive of claim 15, further comprising:
an observation window cover that is engageable with the observation window to obstruct the observation window.

18. The hexagonal beehive of claim 11, wherein:
each of the plurality of hexagonal frame members is spaced apart from an adjacent one of the plurality of hexagonal frame members by between about 0.125 and 0.5 inches.

19. The hexagonal beehive of claim 11, wherein:
the at least one vent element comprises a vent positioned proximate a top of the back of the hive body.

20. The hexagonal beehive of claim 11, further comprising:
at least one vent cover that is configured to be removably secured with each of the at least one vent element to seal the hexagonal beehive.
